(19) United States
(12) Patent Application Publication
(10) Pub. No.: US 2023/0328691 A1
(43) Pub. Date: Oct. 12, 2023

(54) APPARATUS AND METHOD FOR RECEIVING PAGING-RELATED INFORMATION

(71) Applicant: Samsung Electronics Co., Ltd., Suwon-si (KR)

(72) Inventor: Anil AGIWAL, Suwon-si (KR)

(21) Appl. No.: 18/296,688

(22) Filed: Apr. 6, 2023

(30) Foreign Application Priority Data
Apr. 7, 2022 (KR) 10-2022-0043373

(51) Int. Cl. H04W 68/02; H04W 76/30; H04W 76/20

(52) U.S. Cl. CPC H04W 68/02; H04W 76/30; H04W 76/20

(57) ABSTRACT

The disclosure relates to a 5^{th}-generation (5G) or 6^{th}-generation (6G) communication system for supporting a higher data transmission rate. A method for monitoring paging by a user equipment (UE) in a wireless communication system is provided. The method includes receiving, from a cell, system information including paging early indication (PEI) configuration, identifying whether a parameter is configured via the system information, wherein the parameter indicates that the UE monitors PEI only if the latest received RRC release message is from the cell, in case that the parameter is configured, identifying whether an radio resource control (RRC) release message is received most recently in the cell, and in case that the parameter is configured and the RRC release message is received most recently in the cell, monitoring PEI in the cell.

### CROSS-REFERENCE TO RELATED APPLICATION(S)

This application is based on and claims priority under 35 U.S.C. § 119(a) of a Korean patent application number 10-2022-0043373, filed on Apr. 7, 2022, in the Korean Intellectual Property Office, the disclosure of which is incorporated by reference herein in its entirety.

### BACKGROUND

### 1. Field

The disclosure relates to an apparatus and a method for receiving paging-related information in a wireless communication system.

### 2. Description of Related Art

5th generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as Full Dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for receiving paging related information.

Another aspect of the disclosure is to provide an apparatus and a method for monitoring paging by a user equipment (UE).

Additional aspects will be set forth in part in the description which follows and, in part, will be apparent from the description, or may be learned by practice of the presented embodiments.

In accordance with an aspect of the disclosure, a method for monitoring paging by a UE in a wireless communication system is provided. The method may include receiving, from a cell, system information including paging early indication (PEI) configuration, identifying whether a parameter is configured via the system information, wherein the parameter indicates that the UE monitors PEI only if the latest received RRC release message is from the cell, in case that the parameter is configured, identifying whether an radio resource control (RRC) release message is received most recently in the cell, and in case that the parameter is configured and the RRC release message is received most recently in the cell, monitoring PEI in the cell.

In accordance with another aspect of the disclosure, a UE for monitoring paging in a wireless communication system is provided. The UE may include a transceiver, and at least one processor connected with the transceiver. and the at least one processor may be configured to receive, from a cell, system information including PEI configuration, identify whether a parameter is configured via the system information, wherein the parameter indicates that the UE monitors PEI only if the latest received RRC release message is from the cell, in case that the parameter is configured, identify whether an radio resource control (RRC) release message is received most recently in the cell, and in case that the parameter is configured and the RRC release message is received most recently in the cell, monitor PEI in the cell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system structure for paging a user equipment (UE) according to an embodiment of the disclosure;

FIG. 2 illustrates a paging monitoring with paging early indication according to an embodiment of the disclosure;

FIG. 3 illustrates scenarios of paging early indication (PEI) monitoring for the case UE enters a radio resource control (RRC) IDLE state from an RRC_CONNECTED state according to an embodiment of the disclosure;

FIGS. 4 and 5 illustrate various scenarios of PEI monitoring for the case a UE enters RRC INACTIVE from RRC_CONNECTED state according to various embodiments of the disclosure;

FIG. 6 illustrates a flowchart for UE paging procedure according to an embodiment of the disclosure;

FIG. 7 illustrates a flowchart for UE paging procedure according to an embodiment of the disclosure;

FIG. 8 is a view illustrating a configuration of a UE in a wireless communication system according to an embodiment of the disclosure; and

FIG. 9 is a view illustrating a configuration of a network entity in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element, such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub units. Further, an element or a ‘unit’ may be implemented to reproduce one or more central processing units (CPUs) in a device or a security multimedia card. According to embodiments of the disclosure, a “. . . unit” may include one or more processors.

As used herein, each of such phrases as “A and/or B”, “A or B”, “at least one of A and B”, “at least one of A or B”, “A, B, or C”, “at least one of A, B, and C”, and “at least one of A, B, or C” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

Hereinafter, the operational principle of the disclosure is described below with reference to the accompanying drawings. When determined to make the subject matter of the disclosure unclear, the detailed of the known functions or configurations may be skipped. The terms as used herein are defined considering the functions in the disclosure and may be replaced with other terms according to the intention or practice of the user or operator. Therefore, the terms should be defined based on the overall disclosure.

Hereinafter, the base station may be an entity allocating resource to the UE and may be at least one of a gNode B (gNB), an eNode B (eNB), a Node B (NB), a base station (BS), a wireless access unit, a base station controller, or a node over a network. The base station may be a network entity including at least one of an integrated access and backhaul-donor (IAB-donor), which is a gNB providing network access to UE(s) through a network of backhaul and access links in the 5G system, and an IAB-node, which is a radio access network (RAN) node supporting new radio (NR) backhaul links to the IAB-donor or another IAB-node and supporting NR access link(s) to UE(s). The UE is wirelessly connected through the IAB -node and may transmit/receive data to and from the IAB-donor connected with at least one IAB-node through the backhaul link. The user equipment (UE) may include a terminal, mobile station (MS), cellular phone, smartphone, computer, or a multimedia system capable of performing communication functions. Of course, it is not limited to the above examples.

For ease of description, hereinafter, some of the terms and names defined in the 3^{rd} generation partnership project long term evolution (3GPP LTE) or 3GPP new radio (NR) standards may be used. However, the disclosure is not limited by such terms and names and may be likewise applicable to systems conforming to other standards.

In the disclosure, a downlink (DL) is a radio transmission path of a signal transmitted from a base station to a UE, and an uplink (UL) refers to a radio transmission path of a signal transmitted from a UE to a base station.

In the specific description of the embodiments of the disclosure, new RAN (NR), a radio access network on the 5^{th} generation (5G) communication standard specified by the 3^{rd} generation partnership project (3GPP), a wireless communication standardization organization, and a core network although the packet core (5G system, or 5G core network, or next generation core (NG Core)) is targeted, the main gist of the disclosure is that other communication systems having a similar technical background do not greatly deviate from the scope of the disclosure. It can be applied with slight modifications in the range, which will be possible with the judgment of those skilled in the art of the disclosure.

For convenience of description below, some of the terms and names defined in the 3GPP standards (5G, NR, long term evolution (LTE) or similar system standards) may be used. However, the disclosure is not limited by the above terms and names, and may be equally applied to systems conforming to other standards.

A term used in the following description to identify a connection node, a term referring to network entities, a term referring to messages, a term referring to an interface between network entities, and a variety of identification information. Terms and the like are illustrated for convenience of description. Accordingly, the disclosure is not limited to the terms described below, and other terms denoting objects having equivalent technical meanings may be used.

Hereinafter, for convenience of description, the disclosure uses terms and names defined in the 3GPP LTE standard or modified terms and names based thereon. However, the disclosure is not limited by the above-described terms and names, and may be equally applied to systems conforming to other standards. In the disclosure, the term eNB may be used interchangeably with the term gNB for convenience of description. For example, a base station described as an eNB may indicate a gNB. In this disclosure, the term UE may refer to various wireless communication devices, as well as a cell phone, a narrow band-Internet of things (NB-IoT) device, and sensors.

In the detailed description of the embodiments of the disclosure, the communication standard specified in the 3GPP standard will be the main target, but the main gist of the disclosure is that other communication systems having a similar technical background do not greatly deviate from the scope of the disclosure. It can be applied with slight modifications to the extent that it is not, which will be possible with the judgment of those skilled in the technical field of the disclosure.

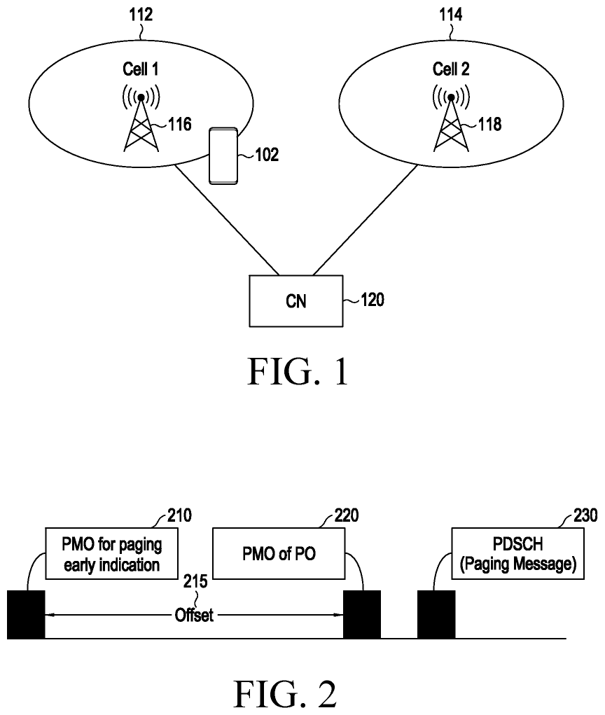

FIG. 1 illustrates a system structure for paging a UE according to an embodiment of the disclosure.

Referring to FIG. 1, a UE 102 is camped on a Cell 1 (112) or a Cell 2 (114). The Cell 1 (112) may be operated by a base station 116 (e.g., gNB 1) and the Cell 2 (114) may be operated by a base station 118 (e.g., gNB 2). The UE 102 may acquire system information (SI) from the camped cell (e.g., the Cell 1 112 or the Cell 2 114). Resource allocations for the UE 102 and the Cells are controlled by one or more a core network (CN) node 120 (e.g., a network function (NF)).

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive multiple-input multiple-output (MIMO), full dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility, or the like. However, it is expected that the design of the air-interface of the fifth generation wireless communication system would be flexible enough to serve the UEs having quite different capabilities depending on the use case and market segment the UE cater service to the end customer.

Few example use cases the fifth generation wireless communication system wireless system is expected to address is enhanced mobile broadband (eMBB), massive machine type communication (m-MTC), ultra-reliable low latency communication (URLL), or the like. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of things (IoT)/Internet of everything (IoE) envisioning connectivity of billions of devices. The URLL requirements like very low latency, very high reliability and variable mobility so on and so forth address the market segment representing the

Industrial automation application, vehicle-to-vehicle/vehicle-to-infrastructure communication foreseen as one of the enabler for autonomous cars.

In the fifth generation wireless communication system operating in higher frequency (mmWave) bands, a UE and a gNB communicates with each other using Beamforming. The beamforming techniques are used to mitigate the propagation path losses and to increase the propagation distance for communication at higher frequency band. The beamforming enhances the transmission and reception performance using a high-gain antenna. The beamforming can be classified into transmission (TX) beamforming performed in a transmitting end and reception (RX) beamforming performed in a receiving end.

In general, the transmit (TX) beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms, such as a linear array, a planar array, or the like. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a receive (RX) signal by using a RX antenna array.

The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple RX/TX UE may be configured to utilise resources provided by two different nodes (or NBs) connected via non-ideal backhaul. One node acts as the master node (MN) and the other as the secondary node (SN). The MN and SN are connected via a network interface and at least the MN is connected to the core network (CN). NR also supports multi-radio access technology (RAT) dual connectivity (MR-DC) operation whereby a UE in RRC_CONNECTED is configured to utilize radio resources provided by two distinct schedulers, located in two different nodes connected via a non-ideal backhaul and providing either evolved-universal terrestrial radio access new radio (E-UTRA) (i.e., if the node is an ng-eNB) or NR access (i.e., if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

In NR the term master cell group (MCG) refers to a group of serving cells associated with the master node, comprising of the primary cell (PCell) and optionally one or more secondary cells (SCells). In NR the term secondary cell group (SCG) refers to a group of serving cells associated with the secondary node, comprising of the primary and secondary cells (PSCell) and optionally one or more SCells. In NR primary cell (PCell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., special cell) refers to the PCell of the MCG or the PSCell of the SCG, otherwise the term special cell refers to the PCell.

In the fifth generation wireless communication system, a physical downlink control channel (PDCCH) is used to schedule downlink (DL) transmissions on a physical downlink shared channel (PDSCH) and UL transmissions on a PUSCH, where downlink control information (DCI) on PDCCH can include at least one of downlink assignments containing at least modulation and coding format, resource allocation, and hybrid-automatic repeat request (ARQ) information related to downlink shared channel (DL-SCH), uplink scheduling grants containing at least modulation and coding format; resource allocation, or hybrid-ARQ information related to UL-SCH. In addition to scheduling, PDCCH can be used to for at least one of activation and deactivation of configured PUSCH transmission with configured grant, activation and deactivation of PDSCH semi-persistent transmission, notifying one or more UEs of the slot format, notifying one or more UEs of the physical resource block(s) (PRB(s)) and orthogonal frequency division multiple (OFDM) symbol(s) where the UE may assume no transmission is intended for the UE, transmission of transmit power control (TPC) commands for PUCCH and PUSCH, transmission of one or more TPC commands for sounding reference signal (SRS) transmissions by one or more UEs, switching a UE's active bandwidth part, or initiating a random access procedure.

A UE may monitor a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations are signaled by a gNB for each configured BWP wherein each search configuration is uniquely identified by an identifier. Identifier of search space configuration to be used for specific purpose, such as paging reception, system information (SI) reception, a random access response reception is explicitly signaled by a gNB. In NR a search space configuration comprises of parameters Monitoring-periodicity-PDCCH-slot, Monitoring-offset-PDCCH-slot, Monitoring-symbols-PDCCH-within-slot and duration. A UE may determine PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below.

(yx(number of slots in a radio frame)+x−Monitoring-offset-PDCCH-slot) mod (Monitoring-periodicity-PDCCH-slot)=0

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. A Search space configuration includes the identifier of CORESET configuration associated with it. A list of CORESET configurations are signaled by GNB for each configured BWP wherein each CORESET configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR.

Each CORESET configuration is associated with a list of Transmission configuration indicator (TCI) states. One DL reference signal ID (RS ID) (e.g., synchronization signal block (SSB) or channel state information reference signal (CSI RS)) is configured per TCI state. The list of TCI states corresponding to a CORESET configuration is signaled by a gNB via a radio resource control (RRC) signaling. One of the TCI state in TCI state list is activated and indicated to UE by gNB. A TCI state indicates the DL TX beam (DL TX beam is quasi-located (QCLed) with SSB/CSI RS of TCI state) used by a gNB for transmission of PDCCH in the PDCCH monitoring occasions of a search space.

In fifth generation wireless communication system bandwidth adaptation (BA) is supported. With BA, the receive and transmit bandwidth of a UE need not be as large as the bandwidth of the cell and can be adjusted the width can be ordered to change (e.g., to shrink during period of low activity to save power), the location can move in the frequency domain (e.g., to increase scheduling flexibility), and the subcarrier spacing can be ordered to change (e.g., to allow different services). A subset of the total cell bandwidth of a cell is referred to as a bandwidth part (BWP). BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell. In RRC connected state, UE is configured with one or more DL and UL BWPs, for each configured serving cell (i.e., PCell or SCell).

For an activated serving cell, there is always one active UL and DL BWP at any point in time. The BWP switching for a serving cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC (medium access control) entity itself upon initiation of random access (RA) procedure. Upon addition of SpCell or activation of a SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC signaling or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the fifth generation wireless communication system, an RRC can be in one of the following states RRC_IDLE, RRC_INACTIVE, and RRC_CONNECTED. A UE is either in an RRC_CONNECTED state or in an RRC_INACTIVE state when an RRC connection has been established. If this is not the case, i.e., no RRC connection is established, the UE is in an RRC_IDLE state. The RRC states may further be characterized as follows:

In the RRC_IDLE, a UE specific DRX (discontinuous reception) may be configured by upper layers. The UE can monitor short messages transmitted with P-RNTI (a paging radio network temporary identifier) over DCI, monitor a paging channel for CN (core network) paging using 5G-S-TMSI (service temporary mobile subscriber identity), perform neighboring cell measurements and cell (re-)selection, acquire system information. And the UE can send SI request (if configured), and perform logging of available measurements together with location and time for logged measurement configured UEs.

In RRC_INACTIVE, a UE specific DRX may be configured by upper layers or by an RRC layer. The UE can store the UE Inactive AS (access stratum) context, a RAN-based notification area is configured by the RRC layer. The UE can monitor short messages transmitted with P-RNTI over DCI, monitor a paging channel for CN paging using 5G-S-TMSI and RAN (radio access network) paging using full I-RNTI (inactive RNTI), perform neighboring cell measurements and cell (re-) selection, perform RAN-based notification area updates periodically and when moving outside the configured RAN-based notification area, acquire system information. The UE can send SI request (if configured), and perform logging of available measurements together with location and time for logged measurement configured UEs.

In RRC_CONNECTED, the UE can store the AS context and transfer of unicast data to/from UE takes place. The UE can monitor short messages transmitted with P-RNTI over DCI, if configured, monitor control channels associated with the shared data channel to determine if data is scheduled for the UE, provide channel quality and feedback information, perform neighboring cell measurements and measurement reporting, and acquire system information.

The 5G or next generation radio access network (NG-RAN) based on NR consists of NG-RAN nodes where NG-RAN node is a gNB, providing NR user plane and control plane protocol terminations towards the UE. The gNBs are also connected by means of the NG interfaces to the SGC, more specifically to the AMF (access and mobility management function) by means of the NG-C (NG control-plane) interface and to the UPF (user plane function) by means of the NG-U (NG user-plane) interface. In the 5^{th} generation (also referred as NR or new radio) wireless communication system, the UE may use discontinuous reception (DRX) in an RRC_IDLE state and an RRC_INACTIVE state in order to reduce power consumption.

In the RRC_IDLE and/or RRC_INACTIVE state, a UE may wake-up at regular intervals (i.e., every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e., S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e., PDCCH is masked with P-RNTI) over data channel (i.e., PDSCH). SI update and emergency notifications are included in DCI and PDCCH carrying this DCI is addressed to P-RNTI.

In the RRC idle/inactive mode a UE can monitor one paging occasion (PO) every DRX cycle. In the RRC idle/inactive mode, the UE can monitor one or more POs in initial DL BWP. In RRC connected state, the UE can monitor one or more POs to receive SI update notification and to receive emergency notifications. The UE can monitor any PO in paging DRX cycle and monitor at least one PO in SI modification period. In the RRC idle/inactive mode, the UE can monitor one or more POs in an active DL BWP of the UE. A PO is a set of ‘S’ PDCCH monitoring occasions for paging, where ‘S’ is the number of transmitted SSBs (i.e., the synchronization signal and PBCH block (SSB) consists of a primary synchronization signal (PSS) and a secondary synchronization signal (SSS) and PBCH) in cell. The UE can first determine a paging frame (PF) and then determine the PO with respect to the determined PF. One PF is a radio frame (10 ms).

For reduce unnecessary UE paging receptions, a paging early indication (PEI) may be introduced (e.g., in R17).

FIG. 2 illustrates a paging monitoring with paging early indication according to an embodiment of the disclosure.

Referring to FIG. 2, the UE may monitor PDCCH in at least one paging monitoring occasion (PMO) 210 of PEI (e.g., early paging indication). The PMO 210 of paging early indication may occur before offset 215 from PMO 220 of paging occasion (PO).

The UE may receive PDCCH in the PMO 210 of paging early indication. A downlink control information (DCI) of the received PDCCH may indicate one or more UE groups for which there is paging. If paging is there for UE's group, the UE monitors at least one PO (e.g., the PMO 220 of PO). The UE may receive a physical downlink shared channel (PDSCH) including a paging message 230 based on monitoring the at least one PO.

In embodiments of the disclosure, a UE power saving for paging monitoring in NR in order to reduce UE power consumption due to false paging alarms, the group of UEs monitoring the same PO can be further divided into multiple subgroups. With subgrouping, a UE can monitor PDCCH in its PO for paging if the subgroup to which the UE belongs is paged as indicated via associated PEI (paging early indication). If a UE cannot find its subgroup ID with the PEI configurations in a cell or if the UE is unable to monitor the associated PEI occasion corresponding to its PO, the UE can monitor the paging in its PO. These subgroups have the following characteristics:
The subgroups are formed based on either CN controlled subgrouping or UE ID based subgrouping;
If specific subgrouping information is not provided from CN, UE ID based subgrouping is used if supported by the UE and a network;
The RRC state (RRC_IDLE or RRC_INACTIVE state) doesn't impact UE subgroup of the UE;
Subgrouping support for RAN is broadcast in the system information as one of the following: Only CN controlled subgrouping supported, Only UE ID based subgrouping supported or both CN controlled subgrouping and UE ID based subgrouping supported;
Total number of subgroupings allowed in a cell is limited to 8 and represents the sum of CN-assigned and UEID-based subgrouping configured by the network; and/or
A UE with CN-assigned subgroup ID can derive UEID-based subgroup ID in a cell supporting only UEID-based subgrouping.

PEI associated with subgroups has the following characteristics:
If the PEI is supported by the UE, the UE can at least support UEID-based subgrouping method;
PEI monitoring can be limited via system information to the cell in which its last connection was released;
A PEI-capable UE can store information a last used cell of the UE; and/or
The UE that expects MBS (multicast and broadcast service) group notification can ignore the PEI and monitor paging in one or more POs of the UE.

In CN controlled subgrouping, an AMF can be responsible for assigning subgroup ID to the UE. The total number of subgroups for CN controlled subgrouping can be configured up to 8, e.g., by OAM (operation, administration and maintenance).

In UE ID based subgrouping, a gNB and a UE can determine the subgroup ID based on the UE ID and the total number of subgroups for UE ID based subgrouping in the cell. The total number of subgroups for UE ID based subgrouping is decided by the gNB for each cell and can be different in different cells.

In PEI reception in NR, the UE can use PEI in RRC_IDLE and RRC_INACTIVE states in order to reduce power consumption. If PEI configuration is provided in system information, the UE in RRC_IDLE or RRC_INACTIVE state supporting PEI (except for the UEs expecting multicast session activation notification) can monitor PEI using PEI parameters in system information according to the procedure described below.

If an indication (e.g., lastUsedCellOnly) is configured in system information of a cell, the UE can monitor PEI only in the cell if the UE most recently entered an RRC_IDLE state or an RRC_INACTIVE state (e.g., the UE most recently received an RRC Release message) in this cell. Otherwise, the UE may monitor PEI in the camped cell regardless of which cell the UE most recently entered an RRC_IDLE or RRC_INACTIVE state.

The UE may monitor one PEI occasion per DRX cycle. A PEI occasion (PEI-O) is a set of PDCCH monitoring occasions (MOs) and can consist of multiple time slots (e.g., subframe or OFDM symbol) where PEI can be sent. The time location of PEI-O for UE's PO is determined by a reference point and an offset from the reference point to the start of the first PDCCH monitoring occasion of this PEI-O.

The reference point is the start of a reference frame determined by a frame-level offset from the start of the first PF of the PF(s) associated with the PEI-O, provided by PEI-F_offset in system information block 1 (SIB1).

The offset is a symbol-level offset from the reference point to the start of the first PDCCH MO of PEI-O, provided by firstPDCCH-MonitoringOccasionOfPEI-O in SIB1.

If one PEI-O is associated with POs of two PFs, the two PFs are consecutive PFs calculated by the parameters PF_offset, T, Ns, and N. The first PF of the PFs associated with the PEI-O is provided by ((SFN for PF)−floor (i_{PO}/Ns)×TIN, ipo=((UE_ID mod N)×Ns+i_s) mod po-NumPerPEI, and po-NumPerPEI is configured via SIB, T, Ns, and N are same as determined to calculate PO.

The PDCCH monitoring occasions for PEI are determined according to pei-SearchSpace, PEI-F offset, firstPDCCH-MonitoringOccasionOfPEI-O and nrofPDCCH-MonitoringOccasionPerSSB-InPO if configured. When SearchSpaceId=0 is configured for pei-SearchSpace, the PDCCH monitoring occasions for PEI are same as for RMSI. UE determines first PDCCH MO for PEI-O based on PEI-F offset and firstPDCCH-MonitoringOccasionOfPEI-O, as for the case with SearchSpaceId>0 configured.

When SearchSpaceId=0 is configured for peiSearchSpac, the UE monitors the PEI-O according to searchSpaceZero. When SearchSpaceId other than 0 is configured for peiSearchSpace, the UE monitors the PEI-O according to the SearchSpace of the configured SearchSpaceId.

A PEI occasion is a set of ‘S*X’ consecutive PDCCH monitoring occasions, where ‘S’ is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]^{th} PDCCH monitoring occasion for PEI in the PEI occasion corresponds to the K^{th} transmitted SSB, where x=0,1, . . . ,X−1, K=1,2, . . . ,S. The PDCCH monitoring occasions for PEI which do not overlap with UL symbols (determined according to tdd-UL-DL-ConfigurationCommon) are sequentially numbered from zero starting from the first PDCCH monitoring occasion for PEI in the PEI-O. When the UE detects a PEI within its PEI-O, the UE is not required to monitor the subsequent monitoring occasion(s) associated with the same PEI-O.

If the UE detects PEI and the PEI indicates the subgroup the UE belongs to monitor its associated PO, the UE can monitor the associated PO. If the UE does not detect PEI on the monitored PEI occasion or the PEI does not indicate the subgroup the UE belongs to monitor its associated PO, the UE is not required to monitor the associated PO. If the UE is unable to monitor the PEI occasion (i.e., all valid PDCCH monitoring occasion for PEI) corresponding to its PO, e.g., during cell re-selection, the UE can monitor the associated PO.

If PEI and subgrouping are configured, UEs monitoring the same PO can be divided into one or more subgroups. With subgrouping, the UE can monitor PO if the corresponding bit for subgroup the UE belongs to is indicated as 1 by PEI corresponding to its PO. UE's subgroup can be either assigned by a CN (e.g., NF 120) or formed based on UE_ID:

If subgroupsNumForUEID is absent in subgroupConfig, the subgroup ID based on CN assigned subgrouping is used in the cell;

If both subgroupsNumPerPO and subgroupsNumForUEID are configured, and subgroupsNumForUEID has the same value as subgroupsNumPerPO, the subgroup ID based on UE_ID based subgrouping is used in the cell; and

If both subgroupsNumPerPO and subgroupsNumForUEID are configured, and subgroupsNumForUEID<sub groupsNumPerPO, the subgroup ID based on CN assigned subgrouping, if available for the UE, is used in the cell; otherwise, the subgroup ID based on UE_ID based subgrouping is used in the cell.

The following parameters are used for the determination of subgroup ID:
subgroupsNumPerPO: number of subgroups for total CN assigned subgrouping (if any) and UE_ID based subgrouping (if any) in a PO, which is broadcasted in system information; and
subgroupsNumForUEID: number of subgroups for UE_ID based subgrouping in a PO, which is broadcasted in system information.

If a UE has no CN assigned subgroup ID or does not support CN-assigned subgrouping, and there is no configuration for subgroupsNumForUEID, the UE can monitor paging in its associated PO.

A paging with CN assigned subgrouping is used in the cell which supports CN assigned subgrouping. A UE supporting CN assigned subgrouping in RRC_IDLE or RRC_INACTIVE state can be assigned a subgroup ID (between 0 to 7) by an AMF through NAS signalling. The UE belonging to the assigned subgroup ID monitors its associated PEI which indicates the paged subgroup(s).

A paging with UE_ID based subgrouping is used in the cell which supports UE_ID based subgrouping. If the UE is not configured with a CN assigned subgroup ID, or if the UE configured with a CN assigned subgroup ID is in a cell supporting only UE_ID based subgrouping, the subgroup ID of the UE is determined by below formula:

SubgroupID=(floor(UE_ID/(N*Ns)) mod subgroupsNumForUEID)+(subgroupsNumPerPO−subgroupsNumForUEID),

where:
N: number of total paging frames in T;
Ns: number of paging occasions for a PF;
UE_ID: 5G-S-TMSI mod X, where X is 32768, if eDRX (enhanced DRX) is applied; otherwise, X is 8192; and
subgroupsNumForUEID: number of subgroups for UE_ID based subgrouping in a PO, which is broadcasted in system information.

A small data transmission (SDT) may include a procedure allowing data and/or signaling transmission while remaining in RRC_INACTIVE state (i.e., without transitioning to RRC_CONNECTED state). The SDT may be enabled on a radio bearer basis and initiated by the UE only if less than a configured amount of UL data awaits transmission across all radio bearers for which SDT is enabled, the DL RSRP (reference signal received power) is above a configured threshold, and a valid SDT resource is available.

The SDT procedure may be initiated with either a transmission over RACH (configured via system information) or over Type 1 cell group (CG) resources (configured via dedicated signaling in RRCRelease). The SDT resources may be configured on initial BWP for both RACH and CG. RACH and CG resources for SDT may be configured on either or both of normal uplink (NUL) and supplementary uplink (SUL) carriers. The CG resources for SDT may be valid only within the cell the UE received RRCRelease and transitioned to RRC_INACTIVE state. For RACH, the network can configure 2-step and/or 4-step RA resources for SDT. When both 2-step and 4-step RA resources for SDT are configured, the UE may select the RA type. A contention free random access (CFRA) may be not supported for the SDT over RACH.

Once initiated, the SDT procedure is either:
successfully completed after the UE is directed to RRC_IDLE (via RRCRelease) or RRC_INACTIVE (via RRCRelease or RRCReject) or to RRC_CONNECTED (via RRCResume or RRCSetup); or
unsuccessfully completed upon cell re-selection, expiry of the SDT failure detection timer, a MAC entity reaching a configured maximum PRACH (physical random access channel) preamble transmission threshold, an RLC (radio link control) entity reaching a configured maximum retransmission threshold, or expiry of SDT-specific timing alignment timer while SDT procedure is ongoing over CG and the UE has not received a response from the network after the initial PUSCH transmission.

Upon unsuccessful completion of the SDT procedure, the UE transitions to RRC_IDLE.

The initial PUSCH transmission during the SDT procedure includes at least the CCCH message. When using CG resources for initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation (dynamic UL grant or DL assignment) for the initial PUSCH transmission from the network. For subsequent UL transmission, the UE cannot initiate re-transmission over a CG resource; and
When using RACH resources, the network can schedule subsequent UL and DL transmissions using dynamic UL grants and DL assignments, respectively, after the completion of the RA procedure.

While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

A SDT procedure over CG resources can only be initiated with valid UL timing alignment. The UL timing alignment is maintained by the UE based on a SDT-specific timing alignment timer configured by the network via dedicated signaling and, for initial CG-SDT transmission, also by DL RSRP of configured number of highest ranked SSBs which are above a configured RSRP threshold. Upon expiry of the SDT-specific timing alignment timer, the CG resources are released while maintaining the CG resource configuration.

Logical channel restrictions configured by the network while in RRC_CONNECTED state and/or in RRCRelease message for radio bearers enabled for the SDT, if any, are applied by the UE during the SDT procedure.

The network (e.g., gNB) may configure the UE to apply ROHC (robust header compression) continuity for the SDT either when the UE initiates the SDT in the cell where the UE received RRCRelease and transitioned to RRC_INACTIVE state or when the UE initiates the SDT in a cell of a RNA (RAN based notification area) of the UE.

Typical paging strategy in the network is as follows:
A UE may be paged in last cell and then UE's is simultaneously paged in multiple cells;
Paging in multiple cells may increase collisions for other UEs (e.g., stationary UEs) on those cells; and
PEI may indicate subgroup(s) which are paged. Sending PEI in every cell where the UE is paged increases false paging for subgroups.

If PEI configuration (e.g., one or more PEI parameters) is provided in system information, the UE in an RRC_IDLE state or an RRC_INACTIVE state supporting PEI may monitor PEI using PEI parameters in the system information according to the procedure described below:

If an indication (e.g., lastUsedCellOnly) is configured in system information of a cell, the UE may monitor PEI only in the cell if the UE most recently entered an RRC_IDLE state or an RRC_INACTIVE state in this cell; and/or

If lastUsedCellOnly is not configured in system information of a cell, the UE may monitor PEI in the cell regardless of which cell the UE most recently entered an RRC_IDLE state or an RRC_INACTIVE state.

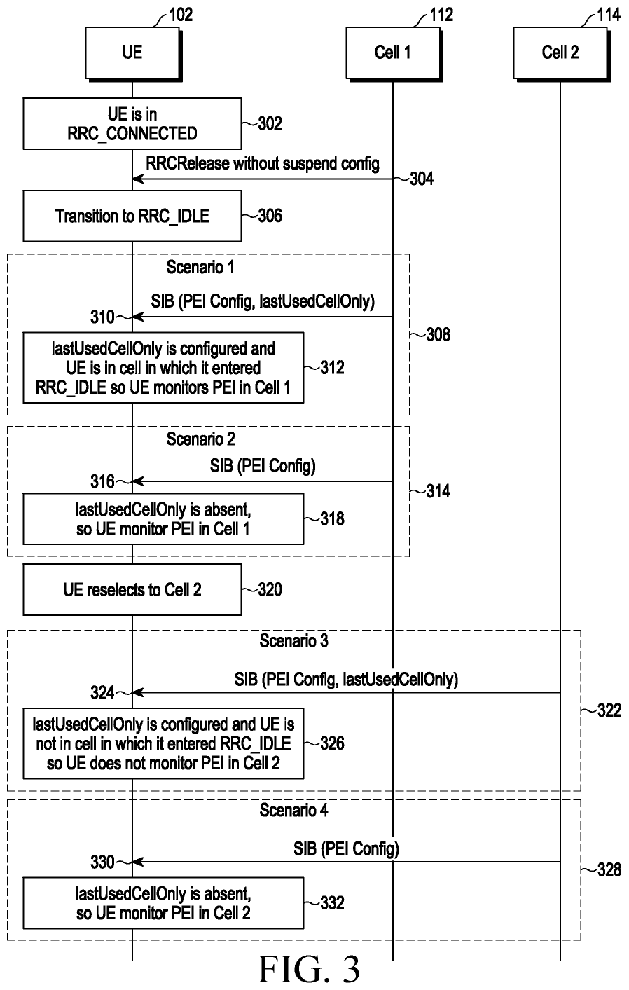

FIG. 3 illustrates scenarios of PEI monitoring for the case UE enters an RRC IDLE state from an RRC_CONNECTED state according to an embodiment of the disclosure. At least one of the operations described below may be omitted, modified, or reordered according to various embodiments.

Referring to FIG. 3, in operation 302, the UE (e.g., the UE 102) may be in RRC_CONNECTED state. In operation 304, the Cell 1 (e.g., Cell 1 112) (e.g., gNB 1) may transmit a signalling message (e.g., an RRCRelease message) without suspend configuration. In operation 306, the UE may transition to an RRC_IDLE state in the Cell 1.

According to a Scenario 1 308, in operation 306 the UE may enter the RRC_IDLE state in the Cell 1. In operation 310, the Cell 1 (e.g., gNB 1) may broadcast PEI configuration and a parameter (e.g., lastUsedCellOnly). In operation 312, the lastUsedCellOnly is configured and the UE is in a cell (e.g., the Cell 1) in which the UE entered the RRC_IDLE state so the UE may monitor PEI (e.g., PEI occasion) in the Cell 1.

According to a Scenario 2 314, in operation 306, the UE may enter the RRC_IDLE state in the Cell 1. In operation 316, the Cell 1 (e.g., gNB 1) may broadcast PEI configuration and does not signal a parameter lastUsedCellOnly. In operation 318, the lastUsedCellOnly is not configured so the UE may monitor PEI in the Cell 1.

According to a Scenario 3 322, in operation 306 the UE may enter the RRC_IDLE state in the Cell 1. In operation 320, the UE in the RRC_IDLE state may reselect to a Cell 2 (e.g., Cell 2 114). In operation 324, the Cell 2 (e.g., gNB 2) may broadcast PEI configuration and a parameter lastUsedCellOnly. In operation 326, the lastUsedCellOnly is configured and the UE is not in a cell (e.g., the Cell 1) in which the UE entered the RRC_IDLE state so UE may not monitor PEI in the Cell 2.

According to a Scenario 4 328, in operation 306 the UE may enter the RRC_IDLE state in the Cell 1. In operation 320, the UE in the RRC_IDLE state may reselect to the Cell 2. In operation 330, the Cell 2 (e.g., gNB 2) may broadcast PEI configuration and does not signal a parameter lastUsedCellOnly. In operation 332, the lastUsedCellOnly is not configured, so the UE may monitor PEI in the Cell 2.

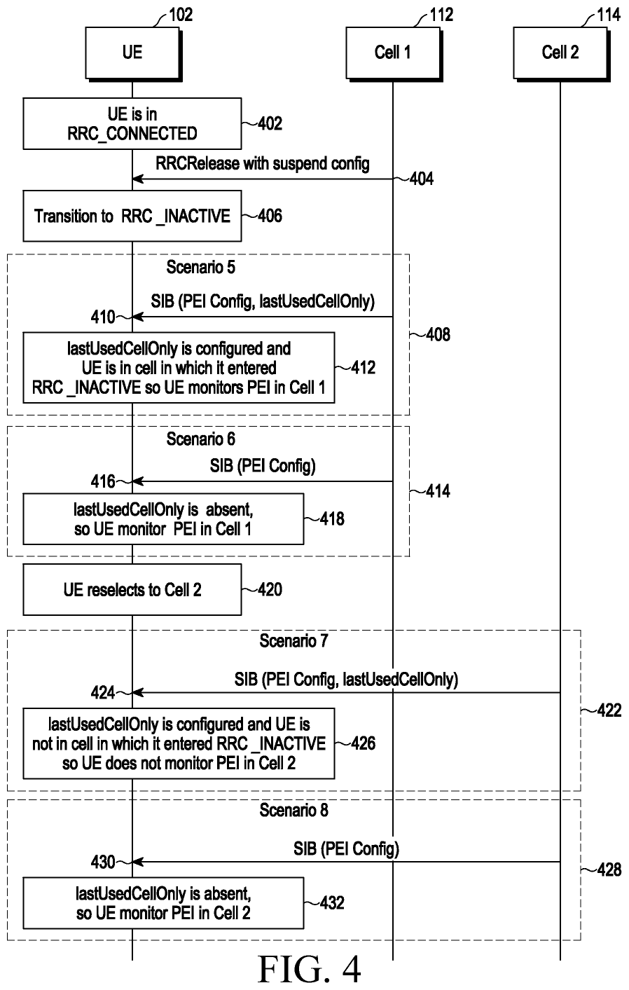

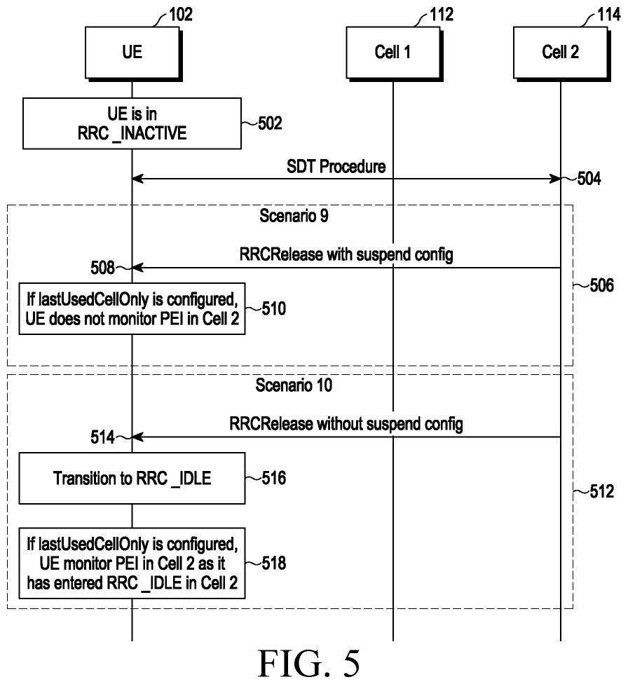

FIGS. 4 and 5 illustrate various scenarios of PEI monitoring for the case a UE enters RRC INACTIVE from RRC_CONNECTED state according to various embodiments of the disclosure. At least one of the operations described below may be omitted, modified, or reordered according to various embodiments.

Referring to FIG. 4, in operation 402, the UE (e.g., the UE 102) may be in RRC_CONNECTED state. In operation 404, the Cell 1 (e.g., Cell 1 112) (e.g., gNB 1) may transmit a signalling message (e.g., an RRCRelease message) without suspend configuration. In operation 406, the UE may transition to an RRC_INACTIVE state in the Cell 1.

According to Scenario 5 408, in operation 406 the UE may enter the RRC_INACTIVE state in the Cell 1. In operation 410, the Cell 1 (e.g., gNB 1) may broadcast PEI configuration and a parameter lastUsedCellOnly. In operation 412, the lastUsedCellOnly is configured and the UE is in a cell (e.g., the Cell 1) in which the UE entered the RRC_INACTIVE state so the UE may monitor PEI in the Cell 1.

According to Scenario 6 414, in operation 406, the UE may enter the RRC_INACTIVE state in the Cell 1. In operation 416, the Cell 1 (e.g., gNB 1) may broadcast PEI configuration and does not signal a parameter lastUsedCellOnly. In operation 418, the lastUsedCellOnly is not configured so the UE may monitor PEI in the Cell 1.

According to Scenario 7 422, in operation 406 the UE may enter the RRC_INACTIVE state in the Cell 1. In operation 424 the UE in the RRC_INACTIVE state may reselect to a Cell 2 (e.g., Cell 2 114). In operation 42, the Cell 2 (e.g., gNB 2) may broadcast PEI configuration and a parameter lastUsedCellOnly. In operation 426, the lastUsedCellOnly is configured and the UE is not in a cell (e.g., the Cell 1) in which the UE entered the RRC_INACTIVE state so the UE may not monitor PEI in the Cell 2.

According to Scenario 8 428, in operation 406 the UE may enter the RRC_INACTIVE state in the Cell 1. In operation 420, the UE in the RRC_INACTIVE state may reselect to the Cell 2. In operation 430, the Cell 2 (e.g., gNB 2) may broadcast PEI configuration and does not signal a parameter lastUsedCellOnly. In operation 432, the lastUsedCellOnly is not configured, so the UE may monitor PEI in the Cell 2.

Referring to FIG. 5, in operation 502, a UE (e.g., the UE 102) may be in a Cell 1 (e.g., the Cell 1 112) and enter an RRC_INACTIVE state. Then a SDT procedure for a Cell 2 (e.g., the Cell 2 114) may be initiated.

According to Scenario 9 506, in operation 502 the UE enters the RRC_INACTIVE state in the Cell 1. In operation 504, the UE may reselect to the Cell 2 and the SDT procedure may be initiated in the RRC_INACTIVE state. In operation 508, the SDT procedure may be completed by receiving an RRC Release message (e.g., RRCRelease) including suspend configuration, and the UE may continue in the RRC_INACTIVE state. Although not shown, the Cell 2 (e.g., gNB 2) may broadcast PEI configuration and a parameter lastUsedCellOnly. In operation 510, the lastUsedCellOnly is configured and the UE is not in a cell (e.g., the Cell 1) in which the UE entered the RRC_INACTIVE state, so the UE may monitor PEI in the Cell 2. Note that the UE entered the RRC_INACTIVE state in the Cell 1.

According to Scenario 10 512, in operation 502, the UE 102 may enter an RRC_INACTIVE state in a Cell 1 112. In the RRC_INACTIVE state, the UE may reselect to a Cell 2 114. A SDT procedure may be initiated in the RRC_INACTIVE state. In operation 514, the SDT procedure may be completed upon receiving the RRC Release message without suspend configuration, and the UE may enter an RRC_IDLE state. Although not shown, the Cell 2 114 (e.g., gNB 2) may broadcast PEI configuration and a parameter lastUsedCellOnly. In operation 516, the UE may transition to an RRC_IDLE state. In operation 518, the lastUsedCellOnly is configured and the UE is in a cell (e.g., the Cell 2 114) in which the UE entered the RRC_IDLE state, so the UE may monitor PEI in the Cell 2. Note that the UE entered the RRC_INACTIVE state in the Cell 1 and the RRC_IDLE state in the Cell 2.

The issue is that in the scenario 9 510, the last serving cell with which the UE performed data communication is the cell 2 and the cell 2 has UE's context but the UE cannot monitor PEI in the cell 2 as the UE has not entered the current RRC state in the cell 2.

### Method 1

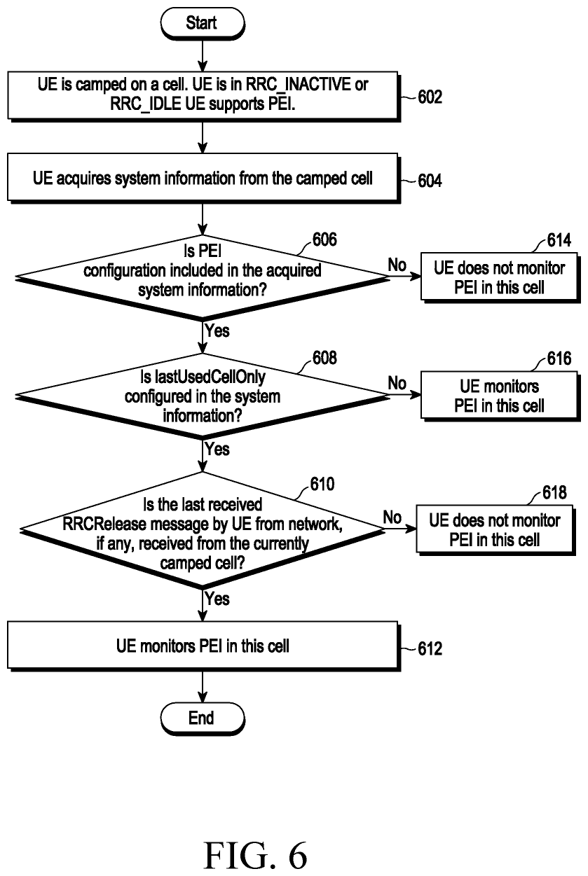

FIG. 6 illustrates a flowchart for UE paging procedure according to an embodiment of the disclosure. At least one of the shown operations may be performed by the processor (e.g., a processor 810) of the UE (e.g., the UE 102). At least one of the operations described below may be omitted, modified, or reordered according to various embodiments.

Referring to FIG. 6, in operation 602, the UE (e.g., the UE 102) may be camped on a cell (e.g., the Cell 1 112 or the Cell 2 114). The UE 102 may be in an RRC_INACTIVE state or an RRC_IDLE state. The UE 102 may support PEI.

In operation 604, the UE 102 may acquire system information from the camped cell.

In operation 606, the UE 102 may check whether the PEI configuration is included in the acquired system information (e.g., in SIB1 or in another SIB). If not, in operation 614, the UE 102 may not monitor PEI (e.g., at least one PMO for PEI) in this cell (e.g., the camped cell). If yes, the UE 102 goes to operation 608.

In operation 608, the UE 102 may check whether lastUsedCellOnly is configured in the acquired system information or not. If not, in operation 616, the UE 102 may monitor PEI in this cell. If yes, the UE 102 goes to operation 610. In operation 610, the UE 102 may check whether the last received RRCRelease message is received by the UE 102 from a network (e.g., a cell) and the last received RRCRelease message is received from the currently camped cell. If not, in operation 618, the UE 102 may not monitor PEI in this cell. If yes, in operation 612, the UE 102 may monitor PEI in this cell.

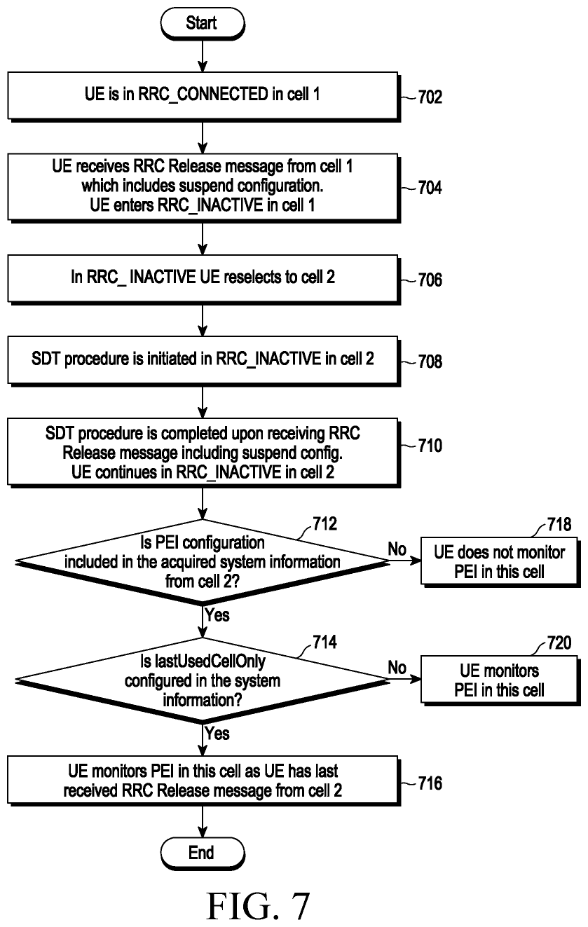

FIG. 7 illustrates a flowchart for UE paging procedure according to an embodiment of the disclosure. At least one of the shown operations may be performed by the processor (e.g., the processor 810) of the UE (e.g., the UE 102). At least one of the operations described below may be omitted, modified, or reordered according to various embodiments.

Referring to FIG. 7, in operation 702, the UE (e.g., the UE 102) may be camped on a cell (e.g., the Cell 1 112), and the UE 102 may be in an RRC_CONNECTED state.

In operation 704, the UE 102 may receive an RRC release message from the cell 1 (e.g., gNB 1) which includes suspend configuration, and enter an RRC_INACTIVE state in the cell 1.

In operation 706, the UE 102 in the RRC_INACTIVE state may reselect to a cell 2 (e.g., the Cell 2 114).

In operation 708, a SDT procedure may be initiated in the RRC_INACTIVE state in the cell 2.

In operation 710, the SDT procedure may be completed upon receiving an RRC release message including suspend configuration, and the UE may continue in the RRC_INACTIVE state in the cell 2. The UE may acquire system information from the camped cell (e.g., the cell 2).

In operation 712, the UE 102 may check whether PEI configuration is included in the acquired system information of the cell 2 or not. If not, in operation 718, the UE 102 may not monitor PEI is the cell 2. If yes, the UE 102 goes to operation 714. In operation 714, the UE 102 may check whether an indication lastUsedCellOnly is configured in the system information or not. If not, in operation 720, the UE 102 may monitor PEI in the cell 2. If yes, the UE 102 goes to operation 716. In operation 716, the UE may monitor PEI in the cell 2 as the UE 102 has the last received RRC release message from the cell 2.

If the UE 102 supports PEI and the PEI configuration (e.g., one or more PEI parameters) is included in the acquired system information and the UE 102 is in an RRC_IDLE state or an RRC_INACTIVE state, the UE 102 may monitor PEI using the PEI parameters (e.g., at least one of po-NumPerPEI-r17, payloadSizeDCI-2-7-r17, pei-FrameOffset-r17, subgroupConfig-r17 (including subgroupsNumPerPO-r17 and/or subgroupsNumForUEID-r17), lastUsedCellOnly-r17, pei-SearchSpace, or firstPDCCH-MonitoringOccasionOfPEI-O) as per the following rules (e.g., a procedure of FIG. 6):

If lastUsedCellOnly is configured in the acquired system information of a cell (e.g., the camped cell), the UE may monitor PEI in this cell only if the UE most recently received (or last received) RRCRelease message in this cell (If yes of operation 608 and yes of operation 610); and/or

If lastUsedCellOnly is not configured in the acquired system information of a cell (e.g., the camped cell), the UE may monitor PEI in the cell regardless of which cell the UE most recently entered an RRC_IDLE state or an RRC_INACTIVE state (If no, in operation 608).

In case one or more PEI parameters are BWP specific, the UE may use the PEI parameters corresponding to (or configured for) the initial DL BWP on which the UE may monitor paging. The initial DL BWP can be the DL BWP indicated by field initialDownlinkBWP in SIB1 or the initial DL BWP can be the DL BWP indicated by field initialDownlinkBWP-RedCap-r17 in SIB1. If UE is redcap UE, it may monitor paging in DL BWP indicated by field initialDownlinkBWP-RedCap-r17 in SIB1 if pagingSearchSpace is configured in this BWP (or cell defining SSBs are present in this BWP). If UE is not redcap UE it monitors paging in DL BWP indicated by field initialDownlinkBWP in SIB1.

The ‘lastUsedCellOnly is configured in system information of a cell’ means that the parameter lastUsedCellOnly present in SIB1 received from the cell. In case the parameter lastUsedCellOnly is BWP specific, ‘lastUsedCellOnly is configured in system information of a cell’ means that the parameter lastUsedCellOnly is present in system information for the initial DL BWP on which UE monitors paging. The initial DL BWP may be the DL BWP indicated by field initialDownlinkBWP in SIB1 or the initial DL BWP can be the DL BWP indicated by field initialDownlinkBWP-RedCap-r17 in SIB1.

The ‘lastUsedCellOnly is configured in system information of a cell’ means that the parameter lastUsedCellOnly present in SIB1 received from the cell. In case the parameter lastUsedCellOnly is BWP specific, ‘lastUsedCellOnly is configured in system information of a cell’ means that the parameter lastUsedCellOnly is present in system information for the initial DL BWP on which UE monitors paging. The initial DL BWP may be the DL BWP indicated by field initialDownlinkBWP in SIB1 or the initial DL BWP can be the DL BWP indicated by field initialDownlinkBWP-RedCap-r17 in SIB1.

A Redcap UE is a UE with reduced capabilities as specified in in TS 38.306. The RedCap UE may be the UE with the following reduced capability:
The maximum bandwidth is 20 megahertz (MHz) for frequency range 1 (FR1), and is 100 MHz for FR2. UE features and corresponding capabilities related to UE bandwidths wider than 20 MHz in FR1 or wider than 100 MHz in FR2 are not supported by RedCap UEs;
The maximum mandatory supported data radio bearer (DRB) number is 8;
The mandatory supported packet data convergence protocol (PDCP) serial number (SN) length is 12 bits while 18 bits being optional;
The mandatory supported RLC acknowledge mode (AM) SN length is 12 bits while 18 bits being optional;
1 DL MIMO layer if 1 Rx branch is supported, and 2 DL MIMO layers if 2 Rx branches are supported. UE features and corresponding capabilities related to more than 2 UE Rx branches and more than 2 DL MIMO layers, as well as UE features and capabilities related to more than 2 UE Tx branches and more than 2 UL MIMO layers are not supported by RedCap UEs; and/or
carrier aggregation (CA), MR-DC, DAPS, conditional PSCell addition/change (CPAC) and IAB (i.e., the RedCap UE is not expected to act as IAB node) related UE features and corresponding capabilities are not supported by RedCap UEs. All other feature groups or components of the feature groups as captured in TR 38.822 [24] as well as capabilities specified in this specification remain applicable for RedCap UEs same as non-RedCap UEs, unless indicated otherwise.

Example scenarios as per this method of the disclosure:

In a Scenario 1 (e.g., the scenario 1 308), the UE may be in an RRC_CONNECTED state in a cell 1. The UE may receive an RRC Release message from the cell 1 which does not include suspend configuration. Upon receiving this RRC Release message, the UE may enter an RRC_IDLE state in the cell 1. The cell 1 (e.g., the base station of the cell 1) may broadcast PEI configuration and a parameter lastUsedCellOnly in system information. As per this method, the UE may support PEI and the PEI configuration may be received from the cell 1 in the system information and lastUsedCellOnly may be configured in the system information of the cell 1 and the UE may have a last received RRC Release message from the cell 1, so the UE may monitor PEI in the cell 1.

In a Scenario 2 (e.g., the scenario 2 314), the UE may be in an RRC_CONNECTED state in a cell 1. The UE may receive an RRC Release message from the cell 1 which does not include suspend configuration. Upon receiving this RRC Release message, the UE may enter an RRC_IDLE state in the cell 1. The cell 1 (e.g., the base station of the cell 1) may broadcast PEI configuration and not signal a parameter lastUsedCellOnly. As per this method, the UE may support PEI and the PEI configuration may be received from the cell 1 in system information and lastUsedCellOnly may not be configured in the system information of the cell 1, so the UE may monitor PEI in the cell 1.

In a Scenario 3 (e.g., the scenario 3 322), the UE may be in an RRC_CONNECTED state in a cell 1. The UE may receive an RRC Release message from the cell 1 which does not include suspend configuration. Upon receiving this RRC Release message, the UE may enter an RRC_IDLE state in the cell 1. In the RRC_IDLE state, the UE may reselect to a cell 2. The cell 2 (e.g., the base station of the cell 2) may broadcast PEI configuration and a parameter lastUsedCellOnly. As per this method, the UE may support PEI and the PEI configuration may be received from the cell 2 in system information and lastUsedCellOnly may be configured in the system information of the cell 2 and the last received RRC Release message of the UE was not from the cell 2, so the UE may not monitor PEI in the cell 2.

In a Scenario 4 (e.g., the scenario 4 328), the UE may be in an RRC_CONNECTED state in a cell 1. The UE may receive an RRC Release message from the cell 1 which does not include suspend configuration. Upon receiving this RRC Release message, the UE may enter an RRC_IDLE state in the cell 1. In the RRC_IDLE state, the UE may reselect to a cell 2. The cell 2 (e.g., the base station of the cell 2) may broadcast PEI configuration and not signal a parameter lastUsedCellOnly. As per this method, the UE may support PEI and the PEI configuration may be received from the cell 2 in system information of the cell 2 and lastUsedCellOnly may be not configured in the system information of the cell 2, so the UE may not monitor PEI in the cell 2.

In a Scenario 5 (e.g., the scenario 5 408), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. The cell 1 (e.g., the base station of the cell 1) may broadcast PEI configuration and a parameter lastUsedCellOnly in system information of the cell 1. As per this method, the UE may support PEI and the PEI configuration may be received from the cell 1 in the system information and lastUsedCellOnly may be configured in the system information of the cell 1 and the UE may have a last received RRC Release message from the cell 1, so the UE may monitor PEI in the cell 1.

In a Scenario 6 (e.g., the scenario 6 414), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. The cell 1 (e.g., the base station of the cell 1) may broadcast PEI configuration and not signal a parameter lastUsedCellOnly. As per this method, the UE may support PEI and the PEI configuration may be received from the cell 1 in the system information and lastUsedCellOnly may not be configured in the system information of the cell 1, so the UE monitors PEI in the cell 1.

In a Scenario 7 (e.g., the scenario 7 422), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. In the RRC_INACTIVE state, the UE may reselect to a cell 2. The cell 2 (e.g., the base station of the cell 2) may broadcast PEI configuration and a parameter lastUsedCellOnly. As per this method, the UE may support PEI and the PEI configuration may be received from the cell 2 in system information of the cell 2 and lastUsedCellOnly may be configured in the system information of the cell 2 and the last received RRC Release message of the UE was not from cell 2, so the UE may not monitor PEI in the cell 2.

In a Scenario 8 (e.g., the scenario 8 428), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. In the RRC_INACTIVE state, the UE may reselect to a cell 2. The cell 2 (e.g., the base station of the cell 2) may broadcast PEI configuration and not signal a parameter lastUsedCellOnly. As per this method, the UE may support PEI and the PEI configuration may be received from the cell 2 in system information of the cell 2 and lastUsedCellOnly may be not configured in the system information of the cell 2, so the UE may not monitor PEI in the cell 2.

In a Scenario 9 (e.g., the scenario 9 506 or a procedure of FIG. 7), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. In the RRC_INACTIVE state, the UE may reselect to a cell 2. A SDT procedure may be initiated in the RRC_INACTIVE state. The SDT procedure may be completed upon receiving the RRC Release message including the suspend configuration. The UE may continue in the RRC_INACTIVE state in the cell 2. The cell 2 (e.g., the base station of the cell 2) may broadcast PEI configuration and a parameter lastUsedCellOnly. The lastUsedCellOnly may be configured and the UE may have a last received RRC Release message from the cell 2, so the UE may monitor PEI in the cell 2. Note that as per existing procedure, the UE did not monitor PEI in the cell 2 in this scenario.

In a Scenario 10 (e.g., the scenario 10 512), the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. In the RRC_INACTIVE state, the UE may reselect to a cell 2. A SDT procedure may be initiated in the RRC_INACTIVE state. The SDT procedure may be completed upon receiving the RRC Release message without a suspend configuration. The UE may enter an RRC_IDLE state. The cell 2 (e.g., the base station of the cell 2) may broadcast PEI configuration and a parameter lastUsedCellOnly. The lastUsedCellOnly may be configured and the UE may have a last received RRC Release message from the cell 2, so the UE may monitor PEI in the cell 2.

In Scenario 11, the UE may be in an RRC_CONNECTED state in a cell 1. The UE may receive an RRC Release message from the cell 1 which includes suspend configuration. Upon receiving this RRC Release message, the UE may enter an RRC_INACTIVE state in the cell 1. In the RRC_INACTIVE state, the UE may reselect to a cell 2. A SDT procedure may be initiated in the RRC_INACTIVE state. The SDT procedure may be unsuccessfully completed (e.g., a SDT timer expires, or a max RLC retransmissions have occurred or a max RA preamble transmissions have occurred, an integrity check failure occurs, or a cell reselection occurs during the SDT procedure), so the UE may enter an RRC_IDLE state. The cell 2 (e.g., the base station of the cell 2) may broadcast PEI configuration and a parameter lastUsedCellOnly. The lastUsedCellOnly may be configured and a last received RRC Release message was not from the cell 2, so the UE may not monitor PEI in the cell 2. Note that as per existing procedure, the UE did monitor PEI in the cell 2 in this scenario.

### Method 2

The UE may be in an RRC_INACTIVE state or an RRC_IDLE state.

The UE may acquire system information from the camped cell.

The UE may check whether the PEI configuration is included in acquired system information (e.g., in SIB1 or in another SIB).

If the UE supports PEI, a PEI configuration is included in the acquired system information, and the UE is in an RRC_IDLE state or an RRC_INACTIVE state, the UE may monitor PEI using PEI parameters (e.g., at least one of po-NumPerPEI-r17, payloadSizeDCI-2-7-r17, pei-FrameOffset-r17, subgroupConfig-r17 (including subgroupsNumPerPO-r17 and/or subgroupsNumForUEID-r17), lastUsedCellOnly-r17, pei-SearchSpace, or firstPDCCH-MonitoringOccasionOfPEI-O) as per the following rules:

If lastUsedCellOnly is configured in the acquired system information of a cell (e.g., the camped cell), the UE may monitor PEI in this cell if the UE most recently entered an RRC_IDLE state from an RRC_CONNECTED state or entered an RRC_INACTIVE state from the RRC_CONNECTED state or the UE continued in the RRC_INACTIVE state in this cell upon successfully completion of the SDT procedure or the UE entered the RRC_IDLE state in this cell upon successfully completion of the SDT procedure;

If lastUsedCellOnly is configured in the acquired system information of a cell (e.g., the camped cell), the UE may monitor PEI in this cell if the UE most recently entered an RRC_IDLE state from an RRC_CONNECTED state or entered an RRC_INACTIVE state from the RRC_CONNECTED state or the UE continued in the RRC_INACTIVE state or entered the RRC_IDLE state upon receiving an RRC Release message in this cell during a latest SDT procedure in this cell; and/or

If lastUsedCellOnly is not configured in the acquired system information of a cell (e.g., the camped cell), the UE may monitor PEI in the cell regardless of which cell the UE most recently entered an RRC_IDLE state or an RRC_INACTIVE state.

In case one or more PEI parameters are BWP specific, the UE may use the PEI parameters corresponding to (or configured for) the initial DL BWP on which the UE monitors paging. The initial DL BWP may be the DL BWP indicated by a field initialDownlinkBWP in SIB1 or the initial DL BWP can be the DL BWP indicated by a field initialDownlinkBWP-RedCap-r17 in SIB1. If the UE is a redcap UE, the UE may monitor paging in a DL BWP indicated by a field initialDownlinkBWP-RedCap-r17 in SIB1 if pagingSearchSpace is configured in this BWP (or a cell defining SSBs are present in this BWP). If the UE is not a redcap UE, the UE may monitor paging in a DL BWP indicated by a field initialDownlinkBWP in SIB1.

The ‘lastUsedCellOnly is configured in system information of a cell’ means that the parameter lastUsedCellOnly present in SIB1 received from the cell. In case the parameter lastUsedCellOnly is BWP specific, ‘lastUsedCellOnly is configured in system information of a cell’ means that the parameter lastUsedCellOnly is present in system information for the initial DL BWP on which UE monitors paging. The initial DL BWP may be the DL BWP indicated by field initialDownlinkBWP in SIB1 or the initial DL BWP may be the DL BWP indicated by field initialDownlinkBWP-RedCap-r17 in SIB1.

### Method 3

In method 3 of the disclosure may introduce “MonitorPEI” indication in an RRCRelease message.

In an embodiment of the disclosure, the “MonitorPEI” indication may be optionally included in the RRCRelease message sent by a gNB during the SDT procedure.

The “MonitorPEI” indication may be included if a current serving cell is served by the same gNB as the last serving gNB is same. In example, the UE may receive an RRCRelease message from a cell 1 (e.g., gNB 1) and enter an RRC_INACTIVE state. In the RRC_INACTIVE state, the UE may reselect to a cell 2 (e.g., gNB 2). The UE may initiate a SDT procedure while camped to the cell 2. The cell 2 (e.g., the gNB 2) may send an RRCRelease message to terminate the SDT procedure. The “MonitorPEI” indication may be included in the RRCRelease message if gNB 1=gNB 2.

The MonitorPEI indication may be included if a current serving cell is served by a different gNB then the last serving gNB but the anchor relocation (from a last serving gNB to a gNB of the current serving cell) is performed during the SDT procedure. In the above example, the MonitorPEI indication may be included in the

RRCRelease message if the gNB 1 is not equal to the gNB 2, but the UE context may be relocated from the gNB1 to the gNB 2.

In an embodiment of the disclosure, the MonitorPEI indication may be optionally included in an RRCRelease message sent by a gNB to release the RRC Connection.

A UE operation of method 3 may be as follows:

The UE may be camped on a cell;

The UE may be in an RRC_INACTIVE state or an RRC_IDLE state;

The UE may acquire system information from the camped cell;

The UE may check whether the PEI configuration is included in acquired system information (e.g., in SIB1 or in another SIB); and

If the UE supports PEI and a PEI configuration is included in the acquired system information and the UE is in an RRC_IDLE state or an RRC_INACTIVE state, the UE may monitor PEI using PEI parameters (e.g., at least one of po-NumPerPEI-r17, payloadSizeDCI-2-7-r17, pei-FrameOffset-r17, subgroupConfig-r17 (including subgroupsNumPerPO-r17 and/or subgroupsNumForUEID-r17), lastUsedCellOnly-r17, pei-SearchSpace, or firstPDCCH-MonitoringOccasionOfPEI-O) as per the following rules:

If lastUsedCellOnly is configured in the acquired system information of a cell (e.g., the camped cell), the UE may monitor PEI in this cell if the UE most recently entered an RRC_IDLE state or an RRC_INACTIVE state in this cell;

If lastUsedCellOnly is configured in the acquired system information of a cell, the UE may monitor PEI in this cell if the last received RRCRelease message (if any) from this cell include MonitorPEI indication (or MonitorPEI indication set to TRUE); and/or

If lastUsedCellOnly is not configured in the acquired system information of a cell, the UE may monitor PEI in the cell regardless of which cell the UE most recently entered an RRC_IDLE state or an RRC_INACTIVE state.

In case one or more PEI parameters are BWP specific, the UE may use the PEI parameters corresponding to (or configured for) the initial DL BWP on which the UE monitors paging. The initial DL BWP may be the DL BWP indicated by a field initialDownlinkBWP in SIB1 or the initial DL BWP can be the DL BWP indicated by field initialDownlinkBWP-RedCap-r17 in SIB1. If the UE is a redcap UE, the UE may monitor paging in a DL BWP indicated by a field initialDownlinkBWP-RedCap-r17 in SIB1 if pagingSearchSpace is configured in this BWP (or cell defining SSBs are present in this BWP). If the UE is not a redcap UE, the UE may monitor paging in a DL BWP indicated by a field initialDownlinkBWP in SIB1.

The ‘lastUsedCellOnly is configured in system information of a cell’ means that the parameter lastUsedCellOnly present in SIB1 received from the cell. In case the parameter lastUsedCellOnly is BWP specific, ‘lastUsedCellOnly is configured in system information of a cell’ means that the parameter lastUsedCellOnly is present in system information for the initial DL BWP on which UE monitors paging. The initial DL BWP can be the DL BWP indicated by field initialDownlinkBWP in SIB1 or the initial DL BWP can be the DL BWP indicated by field initialDownlinkBWP-RedCap-r17 in SIB1.

### Method 4

In method 4 of the disclosure may introduce MonitorPEI indication in an RRCRelease message.

In an embodiment of the disclosure, the MonitorPEI indication may be optionally included in RRCRelease message sent by a gNB during the SDT procedure.

The MonitorPEI indication may be included if a current serving cell is served by the same gNB as the last serving gNB is same. In example, the UE may receive an RRCRelease message from a cell 1 (e.g., gNB 1) and enter an RRC_INACTIVE state. In the RRC_INACTIVE state, the UE may reselect to a cell 2 (e.g., gNB 2). The UE may initiate a SDT procedure while camped to a cell 2. The cell 2 (e.g., the gNB 2) may send an RRCRelease message to terminate the SDT procedure. The MonitorPEI indication may be included in the RRCRelease message if gNB 1=gNB 2.

The MonitorPEI indication may be included if a current serving cell is served by a different gNB then the last serving gNB but the anchor relocation (from a last serving gNB to a gNB of the current serving cell) is performed during the SDT procedure. In the above example, The MonitorPEI indication may be included in the

RRCRelease message if the gNB 1 is not equal to the gNB 2, but the UE context may be relocated from the gNB1 to the gNB 2.

In an embodiment of the disclosure, the MonitorPEI indication may be optionally included in an RRCRelease message sent by a gNB to release the RRC Connection.

A UE operation of method 4 may be as follows:

The UE may be camped on a cell;

The UE may be in an RRC_INACTIVE state or an RRC_IDLE state;

The UE may acquire system information from the camped cell;

The UE may check whether the PEI configuration is included in acquired system information (e.g., in SIB1 or in another SIB); and

If the UE supports PEI and a PEI configuration is included in the acquired system information and the UE is in an RRC_IDLE state or an RRC_INACTIVE state, the UE may monitor PEI using PEI parameters (e.g., at least one of po-NumPerPEI-r17, payloadSizeDCI-2-7-r17, pei-FrameOffset-r17, subgroupConfig-r17 (including subgroupsNumPerPO-r17 and/or subgroupsNumForUEID-r17), lastUsedCellOnly-r17, pei-SearchSpace, or firstPDCCH-MonitoringOccasionOfPEI-O) as per the following rules:

If lastUsedCellOnly is configured in the acquired system information of a cell (e.g., the camped cell), the UE may monitor PEI in this cell if the UE most recently entered an RRC_IDLE state or an RRC_INACTIVE state in this cell;

If lastUsedCellOnly is configured in the acquired system information of a cell (e.g., the camped cell), the UE may monitor PEI in this cell if the last received RRCRelease message (if any) from this cell include MonitorPEI indication (or MonitorPEI indication set to TRUE); and/or

If lastUsedCellOnly is not configured in the acquired system information of a cell (e.g., the camped cell), the UE may monitor PEI in the cell regardless of which cell the UE most recently entered an RRC_IDLE state or an RRC_INACTIVE state.

In case one or more PEI parameters are BWP specific, the UE may use the PEI parameters corresponding to (or configured for) the initial DL BWP on which UE monitors paging. The initial DL BWP may be the DL BWP indicated by a field initialDownlinkBWP in SIB1 or the initial DL BWP may be the DL BWP indicated by a field initialDownlinkBWP-RedCap-r17 in SIB1. If the UE is a redcap UE, the UE may monitor paging in a DL BWP indicated by a field initialDownlinkBWP-RedCap-r17 in SIB1 if pagingSearchSpace is configured in this BWP (or cell defining SSBs are present in this BWP). If the UE is not a redcap UE, the UE may monitor paging in DL BWP indicated by field initialDownlinkBWP in SIB1.

The ‘lastUsedCellOnly is configured in system information of a cell’ means that the parameter lastUsedCellOnly present in SIB1 received from the cell. In case the parameter lastUsedCellOnly is BWP specific, ‘lastUsedCellOnly is configured in system information of a cell’ means that the parameter lastUsedCellOnly is present in system information for the initial DL BWP on which UE monitors paging. The initial DL BWP can be the DL BWP indicated by field initialDownlinkBWP in SIB1 or the initial DL BWP can be the DL BWP indicated by field initialDownlinkBWP-RedCap-r17 in SIB1.

In scenario 9 described above, the last serving cell with which the UE performed data communication is the cell 2 but the UE may not monitor PEI in the cell 2 as the UE has not entered the current RRC state in this cell.

### Solution 1 (That May Correspond to Method 1)

If PEI configuration is provided in system information, the UE in an RRC_IDLE state or an RRC_INACTIVE state supporting PEI may monitor PEI using PEI parameters in system information according to the procedure described below:

If lastUsedCellOnly is configured in system information of a cell, the UE may monitor PEI in this cell only if the UE most recently received an RRCRelease message in this cell; and/or

If lastUsedCellOnly is not configured in system information of a cell, the UE may monitor PEI in the cell regardless of which cell the UE most recently entered an RRC_IDLE state or an RRC_INACTIVE state.

### Solution 2

An MonitorPEI indication is introduced in an RRCRelease message;

The MonitorPEI indication may be optionally included in RRCRelease message sent by gNB during the SDT procedure.

The MonitorPEI indication may be included if current serving cell is served by the same gNB as the last serving gNB is same.

In example, the UE may receive the RRCRelease message from a cell 1 (e.g., gNB 1) and enter an RRC_INACTIVE state. In the RRC_INACTIVE state, the UE may reselect to a cell 2 (e.g., gNB2). The UE may initiate a SDT procedure while camped to the cell 2. The cell 2 may send the RRCRelease message to terminate the SDT procedure.

The MonitorPEI indication may be included in the RRCRelease message if gNB 1=gNB 2.

The MonitorPEI indication may be included if a current serving cell is served by a different gNB then the last serving gNB but the anchor relocation is performed during the SDT procedure.

In the above example, the MonitorPEI indication may be included in the RRCRelease message if the gNB 1 is not equal to the gNB 2, but a UE context may be relocated from the gNB1 to the gNB 2.

An embodiment of a UE operation for the solution 2 may be as follows.

If PEI configuration is provided in system information, the UE in an RRC_IDLE state or an RRC_INACTIVE state supporting PEI may monitor PEI using PEI parameters in system information according to the procedure described below:

If lastUsedCellOnly is configured in the system information of a cell, the UE may monitor PEI in this cell if the UE most recently entered an RRC_IDLE state or an RRC_INACTIVE state in this cell;

If lastUsedCellOnly is configured in the system information of a cell, the UE may monitor PEI in this cell if the last received RRCRelease message from this cell include MonitorPEI indication; and/or

If lastUsedCellOnly is not configured in system information of a cell, the UE may monitor PEI in the cell regardless of which a cell the UE most recently entered an RRC_IDLE state or an RRC_INACTIVE state.

An embodiment of a UE operation for the solution 2 may be as follows.

If PEI configuration is provided in system information, the UE in an RRC_IDLE state or an RRC_INACTIVE state supporting PEI may monitor PEI using PEI parameters in the system information according to the procedure described below:

If lastUsedCellOnly is configured in the system information of a cell, the UE may monitor PEI in this cell if the UE most recently entered an RRC_IDLE state or an RRC_INACTIVE state in this cell;

If lastUsedCellOnly is configured in the system information of a cell, the UE may monitor PEI in this cell if the last received RRCRelease message from this cell include MonitorPEI indication; and/or

If lastUsedCellOnly is not configured in the system information of a cell, the UE may monitor PEI in the cell regardless of which a cell the UE most recently entered an RRC_IDLE state or an RRC_INACTIVE state.

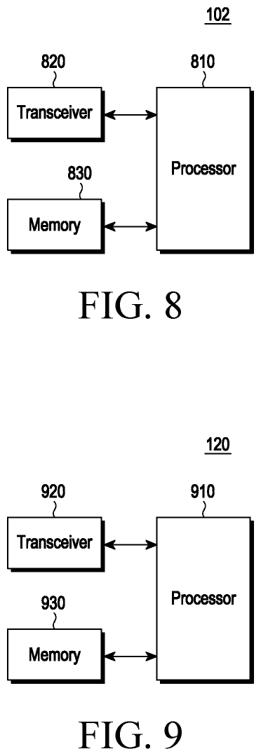

FIG. 8 is a view illustrating a configuration of a UE in a wireless communication system according to an embodiment of the disclosure. The UE 102 of FIG. 8 may operate according to at least one the embodiments of FIGS. 3, 4, 5, 6, and 7.

Referring to FIG. 8, the UE 102 may include the processor 810 controlling the overall operation of the UE 102, a transceiver 820 including a transmitter and a receiver, and a memory 830. Without limited thereto, the UE 102 may include more or less components than those shown in FIG. 8.

According to an embodiment of the disclosure, the transceiver 820 may transmit and/or receive signals to/from at least one network entity (e.g., a base station or a gNB). The transmitted/received signals may include at least one of control information and data.

According to an embodiment of the disclosure, the processor 810 may control the overall operation of the UE 102 to perform operations according to a combination of one or more of the embodiments of FIGS. 3, 4, 5, 6, and 7 described above. The processor 810, the transceiver 820, and the memory 830 are not necessarily implemented in separate modules but rather as one component, such as a single chip. The processor 810 may include at least one of an application processor (AP), a communication processor (CP), a processing circuitry, an application-specific circuit, or at least one processor. The transceiver 820 may include at least one communication interface by wire and/or wirelessly transmitting/receiving signals to/from at least one network entity (e.g., a base station or a gNB).

According to an embodiment of the disclosure, the memory 830 may store a default program for operating the UE 102, application programs, and data, such as configuration information. The memory 830 may provide the stored data according to a request of the processor 810. The memory 830 may include a storage medium, such as a random nonvolatile memory (ROM), a random access memory (RAM), a hard disk, a compact disc read only memory (CD-ROM), and a digital versatile disc (DVD), or a combination of storage media. There may be provided a plurality of memories 830. The processor 810 may perform at least one of the above-described embodiments based on a program for performing operations according to at least one of the above-described embodiments stored in the memory 830.

FIG. 9 is a view illustrating a configuration of a network entity in a wireless communication system according to an embodiment of the disclosure. The network entity may include a base station 116 (e.g., gNB) or a CN 120 (e.g., a NF) and operate according to at least one the embodiments of FIGS. 3, 4, 5, 6, and 7.

Referring to FIG. 9, the base station 116 or the CN 120 may include a processor 910 controlling the overall operation of the base station 116 or the CN 120, a transceiver 920 including a transmitter and a receiver, and a memory 930. Without limited thereto, the base station 116 or the CN 120 may include more or less components than those shown in FIG. 9.

According to an embodiment of the disclosure, the transceiver 920 may transmit and/or receive signals to/from at least one network entity (e.g., the UE 102 or other network entity). The transmitted/received signals may include at least one of control information and data.

According to an embodiment of the disclosure, the processor 910 may control the overall operation of the base station 116 or the CN 120 to perform operations according to a combination of one or more of the embodiments of FIGS. 3, 4, 5, 6, and 7 described above. The processor 910, the transceiver 920, and the memory 930 are not necessarily implemented in separate modules but rather as one component, such as a single chip. The processor 910 may include at least one of an AP, a CP, a processing circuitry, an application-specific circuit, or at least one processor. The transceiver 920 may include at least one communication interface by wire and/or wirelessly transmitting/receiving signals to/from the UE 102 or at least one other network entity (e.g., other base station or a CN).

According to an embodiment of the disclosure, the memory 930 may store a default program for operating the base station 116 or the CN 120, application programs, and data, such as configuration information. The memory 930 may provide the stored data according to a request of the processor 910. The memory 930 may include a storage medium, such as a ROM, a RAM, a hard disk, a CD-ROM, and a DVD, or a combination of storage media. There may be provided a plurality of memories 930. The processor 910 may perform at least one of the above-described embodiments based on a program for performing operations according to at least one of the above-described embodiments stored in the memory 930.

In accordance with an embodiment of the disclosure, a method for monitoring paging by a UE in a wireless communication system is provided. The method may include receiving system information comprising paging early indication (PEI) configuration in a cell while the UE is in a radio resource control (RRC) idle state or an RRC inactive state, based on a parameter related to PEI monitoring of the UE being included in the system information, checking whether the UE most recently received an RRC release message in the cell, and based on identifying that the UE most recently being received the RRC release message in the cell, monitoring a PEI occasion in the cell according to the PEI configuration.

In accordance with an embodiment of the disclosure, a UE for monitoring paging in a wireless communication system is provided. The UE may include a transceiver, and at least one processor connected with the transceiver. The at least one processor may be configured to receive system information comprising PEI configuration in a cell while the UE is in an RRC idle state or an RRC inactive state, based on a parameter related to PEI monitoring of the UE being included in the system information, check whether the UE most recently received an RRC release message in the cell, and based on identifying that the UE most recently being received the RRC release message in the cell, monitor a PEI occasion in the cell according to the PEI configuration.

The methods according to the embodiments descried in the description or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Alternatively, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for monitoring paging by a user equipment (UE) in a wireless communication system, the method comprising:
receiving, from a cell, system information including paging early indication (PEI) configuration;
identifying whether a parameter is configured via the system information, wherein the parameter indicates that the UE monitors PEI only if the latest received RRC release message is from the cell;
in case that the parameter is configured, identifying whether an radio resource control (RRC) release message is received most recently in the cell; and
in case that the parameter is configured and the RRC release message is received most recently in the cell, monitoring PEI in the cell.

2. The method of claim 1, wherein the PEI is monitored in an RRC inactive state or an RRC idle state.

3. The method of claim 1,
wherein in case that the parameter is configured and the RRC release message is not received most recently in the cell, the PEI is not monitored in the cell.

4. The method of claim 3, further comprising:
receiving the RRC release message in a first cell while the UE is in an RRC connected state;
transitioning to the RRC inactive state based on receiving the RRC release message; and
reselecting the cell after transitioning to the RRC inactive state.

5. The method of claim 1, further comprising:
initiating a small data transmission (SDT) procedure in the cell while the UE is in an RRC inactive state;
identifying that the SDT procedure is completed upon receiving the RRC release message including suspend configuration; and
continuing in the RRC inactive state in the cell.

6. The method of claim 5, further comprising:
receiving the RRC release message in a first cell while the UE is in an RRC connected state;
transitioning to the RRC idle state based on receiving the RRC release message; and
reselecting the cell after transitioning to the RRC idle state.

7. The method of claim 1, further comprising:
in case that the parameter is not configured via the system information of the cell, monitoring PEI in the cell regardless of which cell the UE most recently entered an RRC idle state or an RRC inactive state.

8. The method of claim 1, wherein the PEI configuration comprises at least one of:
a first parameter indicating a number of paging occasions (POs) per PEI occasion;
a second parameter indicating a payload size of downlink control information (DCI);
a third parameter indicating a frame offset related to PEI; or
a fourth parameter related to subgroup configuration.

9. A user equipment (UE) for monitoring paging in a wireless communication system, the UE comprising:
a transceiver; and
at least one processor connected with the transceiver and configured to:
receive, from a cell system information including paging early indication (PEI) configuration,
identify whether a parameter is configured via the system information, wherein the parameter indicates that the UE monitors PEI only if the latest received RRC release message is from the cell,
in case that the parameter is configured, identify whether an radio resource control (RRC) release message is received most recently in the cell, and
in case that the parameter is configured and the RRC release message is received most recently in the cell, monitor PEI in the cell.

10. The UE of claim 9, wherein the PEI is monitored in an RRC inactive state or an RRC idle state.

11. The UE of claim 9, wherein in case that the parameter is configured and the RRC release message is not received most recently in the cell, the PEI is not monitored in the cell.

12. The UE of claim 11, wherein the at least one processor is further configured to:
receive the RRC release message in a first cell while the UE is in an RRC connected state,
transition to the RRC inactive state based on receiving the RRC release message, and
reselect the cell after transitioning to the RRC inactive state.

13. The UE of claim 9, wherein the at least one processor is further configured to:
initiate a small data transmission (SDT) procedure in the cell while the UE is in an RRC inactive state,
identify that the SDT procedure is completed upon receiving the RRC release message including suspend configuration; and
continue in the RRC inactive state in the cell.

14. The UE of claim 13, wherein the at least one processor is further configured to:
receive the RRC release message in a first cell while the UE is in an RRC connected state,
transition to the RRC idle state based on receiving the RRC release message, and
reselect the cell after transitioning to the RRC idle state.

15. The UE of claim 9, wherein the at least one processor is further configured to:
in case that the parameter is not configured via the system information of the cell, monitor PEI in the cell regardless of which cell the UE most recently entered an RRC idle state or an RRC inactive state.

16. The UE of claim 9, wherein the PEI configuration comprises at least one
a first parameter indicating a number of paging occasions (POs) per PEI occasion;
a second parameter indicating a payload size of downlink control information (DCI);
a third parameter indicating a frame offset related to PEI; or
a fourth parameter related to subgroup configuration.
